(19) United States
(12) Patent Application Publication
(10) Pub. No.: US 2002/0167382 A1
(43) Pub. Date: Nov. 14, 2002

(54) Electromagnetic closing and opening device for door leaves that can be pivoted

(76) Inventor: Sascha Manthey, Berlin (DE)

Correspondence Address: BRUCE LONDA, NORRIS, MCLAUGHLIN & MARCUS, P.A., 220 EAST 42ND STREET, 30TH FLOOR, NEW YORK, NY, 10017, US

(21) Appl. No.: 09/806,718

(22) PCT Filed: Dec. 21, 2000
(86) PCT No.: PCT/EP00/13106

(30) Foreign Application Priority Data
Dec. 21, 1999 (DE) 199 61 893.3

(51) Int. Cl. H01F 7/08

(52) U.S. Cl. 335/220

(57) ABSTRACT

The aim of the invention is to provide an electromagnetic device for door leaves that can be pivoted, whereby a door closing and stopping device and a door opening device form a constructional unit and a door leaf that can be pivoted and is closed when resting on a door sealing can be securely close. According to the invention, a positive fit is produced between the door leaf (8) that can be pivoted and the frame (1) of the door and between pole flanges (2; 3) of an electromagnetic device and a U-shaped antipole component (11) that is provided with a connecting piece (13) which consists of non-magnetic material, as soon as the door leaf (8) rests on the door stop (20) in the closing position The connecting piece (13) which slightly rises above the anitpole component (11) engages in a gap between the pole flanges (1; 2) in the closing position. The pole surfaces (18) of the pole flanges (1; 2) and the antipole surfaces (17) of the antipole common (11) and the front face (21) of the connecting piece (13) are provided with an angle of incidence (22). The inventive device is not provided with mechanically moved components and is thus not subject to damaging effects caused by the use of external force.

The invention relates to an electrically actuated device for restraining hinged door leaves in the closed position and for opening door leaves restrained in the closed position, whereby the hinged door leaves are held in the closed position by force locking.

In general, catches are known for the locking of hinged door leaves whereby a movable bolt, actuated mechanically or electromagnetically, is brought into the closed position and the movement of the hinged door leaf is hindered by form locking, whereby this closing bolt engages in a coulisse-shaped recess in the fixed doorframe or fixed door leaf.

For the remote operation of locking devices for hinged door leaves whereby locking is accomplished by form locking of a slidable bolt, designs are known whereby the bolt of the locking mechanism is brought into the closed position by magnetic forces. Such a locking device can be actuated electrically both in the closed and in the open position. These closing devices for hinged door leaves also have a bolt catch which restrains the hinged door leaf in the door closed position, whereby this engages in a coulisse-shaped recess in the door frame or in the fixed door leaf and thus the bolt catch becomes effective by form locking. This bolt catch can be actuated mechanically directly or indirectly whereby the form locking between the bolt catch and the coulisse-shaped recess is lifted. Non-locked hinged door leaves which are held in the closed position by the bolt catch can only be opened by means of an additional door opening device which can be electrically actuated. For this purpose there are known additional electromagnetically operating door opening devices which are provided in the door frame or in the fixed door leaf. Various electrically actuatable structures are known as door opening devices whereby a closing plate is unlocked by a magnetic field generated via a magnetic coil. After this unlocking the form locking between the bolt catch and the coulisse-shaped recess is lifted.

All known solutions have the disadvantage that the construction costs for the locking and unlocking and for the opening of a hinged door leaf restrained in the closed position are very high. Furthermore, both the door closers and the door openers have many moving parts so that both the door closing and the door opening mechanism have a very high susceptibility to breakdown.

The aim of the invention is to reduce the susceptibility to breakdown of door opening and closing devices, to lower costs, construction and maintenance expenditure and to ensure secure closing of a hinged door leaf in the closed position and thereafter secure opening.

The problem forming the basis of the invention is to develop a device for hinged door leaves in which both the door closing and restraining device and the door opening device form a structural unit and allow the locking of a hinged door leaf which closes against a door seal whereby the closing and opening device should be capable of being operated remotely.

This problem was solved by the technical characteristics specified in claim 1. The subclaims serve to elaborate the invention.

The invention will be explained hereinafter with reference to an example of embodiment and is shown in the relevant drawings:

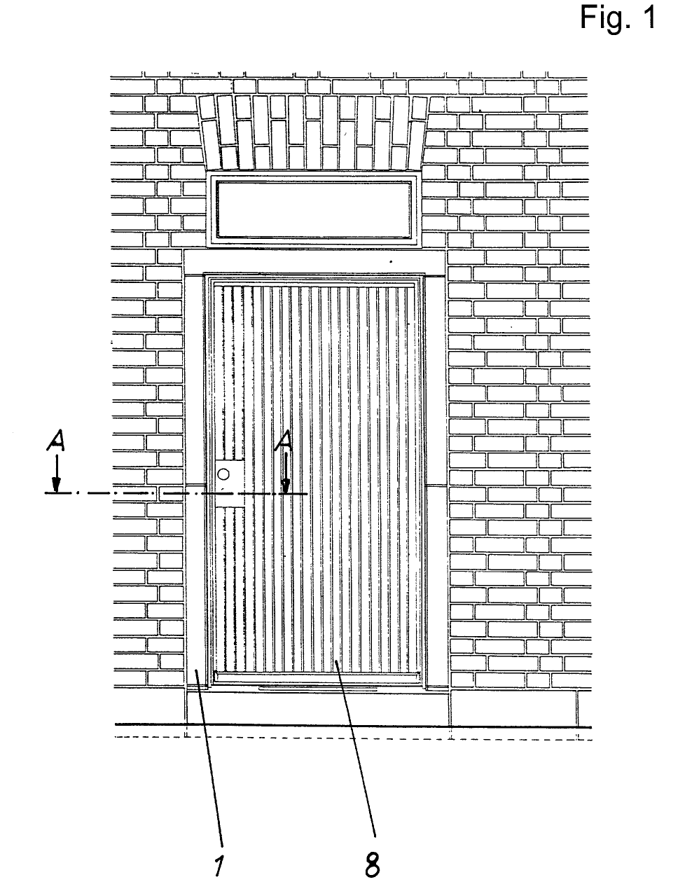

FIG. 1 is a view of an outside door which opens inwards;

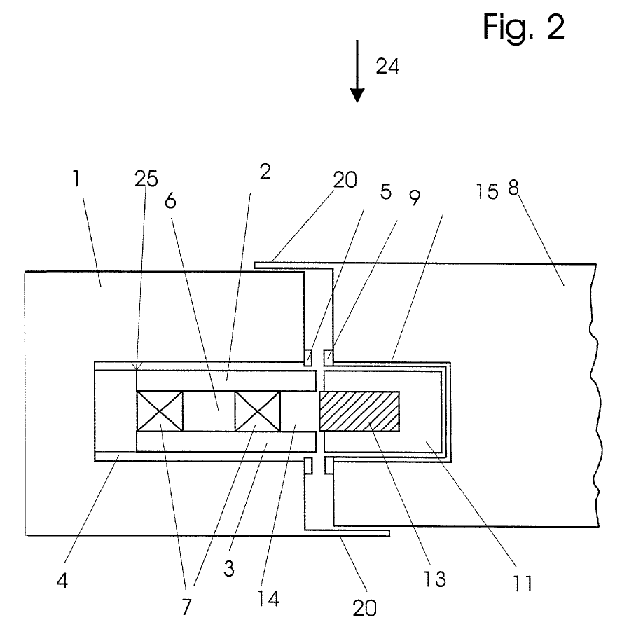

FIG. 2 is a horizontal section A-A as in FIG. 1 through a hinged door leaf in the closed position with a door frame;

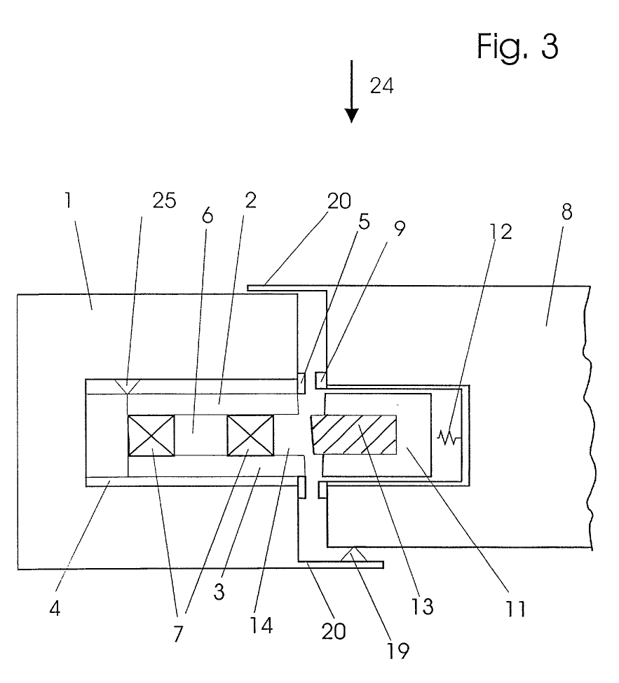

FIG. 3 is a horizontal section A-A as in FIG. 1 through a hinged door leaf closing against a door seal in the closed position

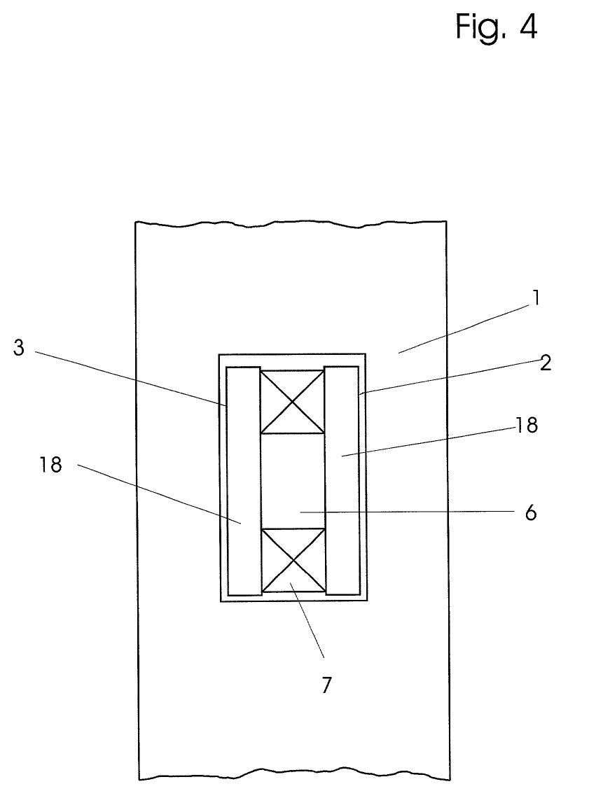

FIG. 4 is a longitudinal section through a door frame with a built-in electrically active part of the closing and opening device developed according to the invention

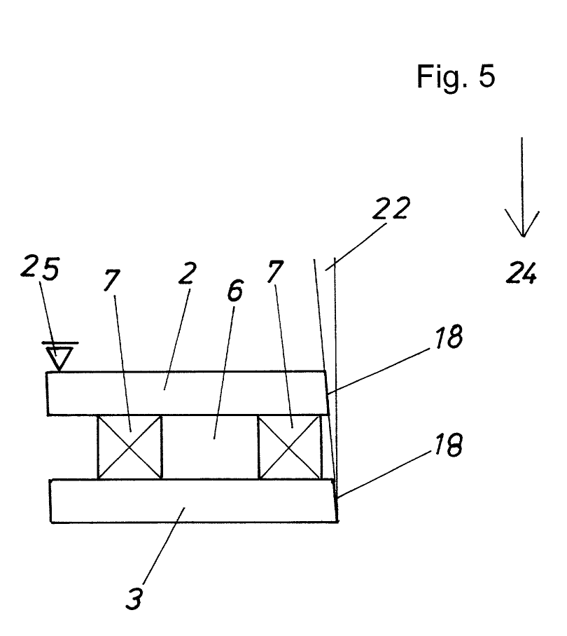

FIG. 5 is the electrically active part in a view B as in FIG. 4

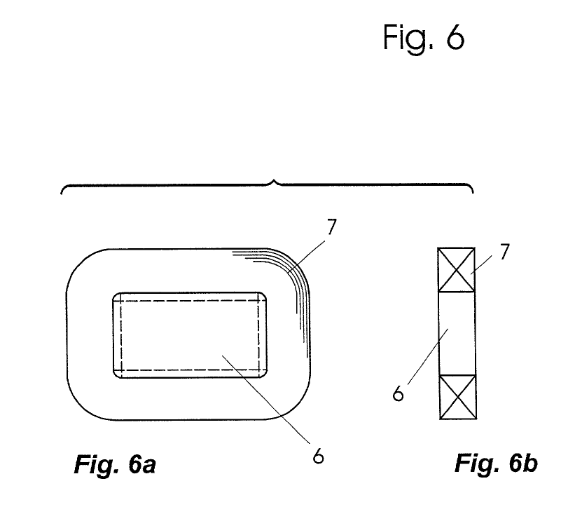

FIG. 6 is a magnetic coil in cross-section and side view

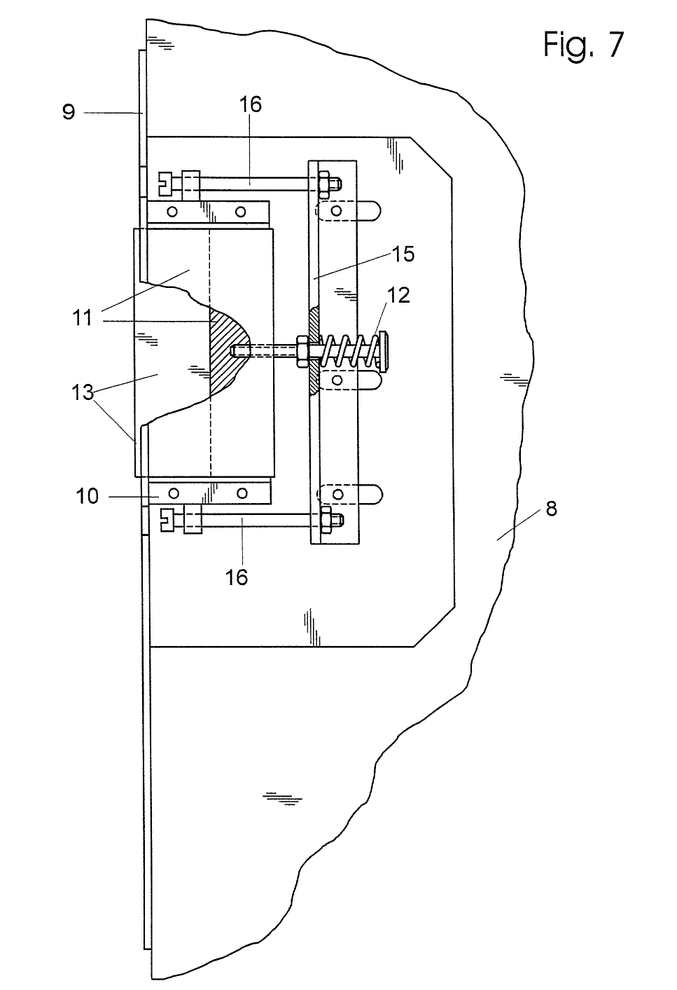

FIG. 7 is a side view of a counterpole piece with intermediate piece built in a frame of a hinged door leaf

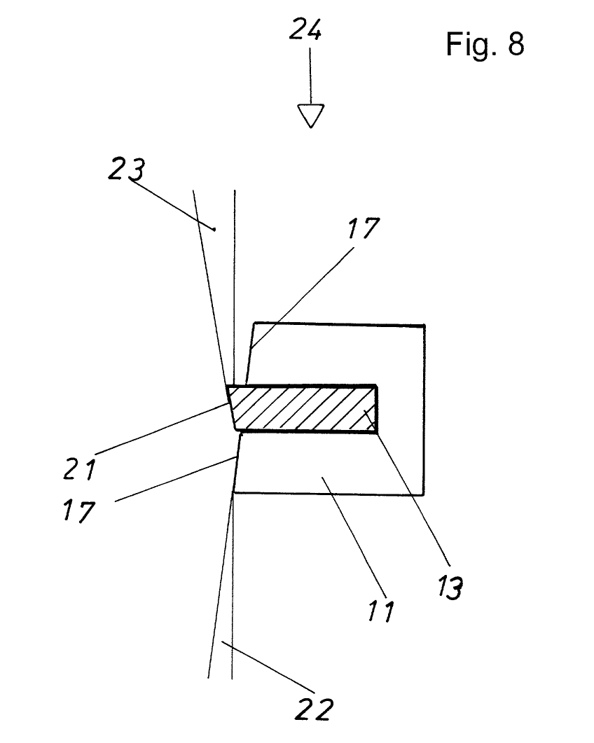

FIG. 8 is a counterpole piece with intermediate piece in view C as in FIG. 7 with pole plates and intermediate piece of the counterpole piece developed according to the invention

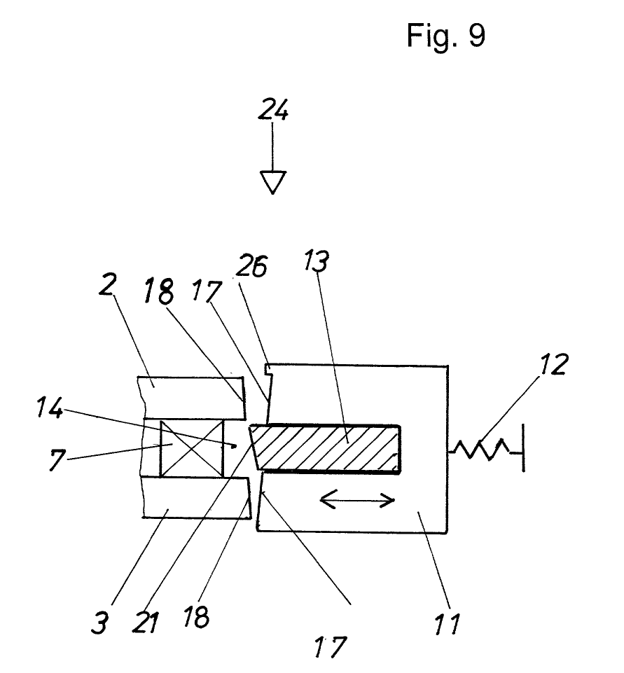

FIG. 9 is a counterpole piece in view C as in FIG. 7 with a nose-shaped projection at a pole plate of the counterpole piece developed according to the invention.

In a door frame 1 or in an upright leaf there is installed the electrically active part of an electromagnetic closing and opening device developed according to the invention. This consists of an electromagnetic device having two pole plates 2; 3 which is accommodated in a frame structure 4 whereby this is mounted on a retaining plate 5 made of non-magnetisable material, for example brass.

The electromagnetic device consists of a yoke 6 and a winding 7 surrounding the yoke 6 to produce an electromagnetic field. The yoke 6 is connected by two pole plates 2; 3. These are made of a material which after decay of the electromagnetic field still exhibits a low remanent magnetism.

In the hinged door leaf 8 there is located on the frame side a closing counterpiece for the electrically active part of the electromagnetic closing and opening device provided in the door frame 1 or in the upright leaf. This closing counterpiece consists of a retaining plate 9 made of a non-magnetisable material on which a framework 10 is attached. In said framework there is provided a U-shaped counterpole piece 11 which can slide horizontally to a small extent, which is connected to a return spring 12 provided in the framework 10.

The device designed according to the invention can either be designed as a closing variant or as an opening variant. In the closing variant the counterpole piece 11 is made of soft iron and on application of a voltage to the winding 7 of the electrically active part the closing and opening device comes into a closed position. In the opening variant according to the invention the counterpole piece 11 consists of a permanent magnet and the electrically active part of the closing and opening device according to the invention is used to open a locked door leaf whereby by application of a voltage to the winding 7 of the electrically active part a magnetic field is produced for which like poles lie opposite to those of the permanent magnet. By this means the closing force of the permanent magnet is lifted.

The U-shaped counterpole piece 11 surrounds a recess. In said recess there is inserted an intermediate piece 13 of non-magnetisable material which projects slightly beyond the pole surfaces of the counterpole piece 11, whereby said intermediate piece extends in the direction of the electrically active part of the electromagnetic closing and opening mechanism and there engages in a free space 14 between the pole plates 2; 3 when the door leaf 2 is closed.

In the event of the magnetic field produced by the closing and opening device provided in the door frame 1 being absent in the closing variant or as a result of the production of a homopolar magnetic field, i.e., as a result of the restraining force produced by a permanent magnet being removed in the opening variant, the counterpole piece 11 falls away and said piece is returned to its initial position by the return spring 12. The return spring 12 is provided at the rear end 15 of the framework 10. The closing counterpiece is secured in the hinged door leaf 8 by means of the retaining plate 9 and can be adjusted by means of two set screws 16.

The working principle of the device in the closing variant consists in that, if the hinged door leaf 8 is brought into the closing position, the counterpole surfaces 17 of the counterpole piece 11 come into the region of the electromagnetic field of the electrically active part of the closing and opening device and the counterpole surfaces 17 of the easily movable counterpole piece 11 built into the hinged door leaf 8 are attracted and thereby restrain the hinged door leaf 8 in the closed position such that on the one hand, there arises a force-locking connection between the pole surfaces 18 of the pole plates 2; 3 and the counterpole surfaces 17 of the movable counterpole piece 11 by closure of the electromagnetic field lines and on the other hand, a form locking connection is made by the intermediate piece 13 engaging in a free space 14 between the pole plates 2; 3. In the opening variant the pole surfaces 18 and the counterpole surfaces 17 come into the closed position as a result of the magnetic field of the permanent magnet and in addition to the magnetic restraining force, a form-locking connection is produced by the intermediate piece 13 engaging in a free space 14 between the pole plates 2; 3.

As soon as the hinged door leaf 8 is to close tightly against a door seal 19 located in a door stop 20, i.e., utilising the elasticity of this door seal 19, the pole surfaces 18 of the pole plates 2; 3, the counterpole surfaces 17 of the counterpole piece 11 and the front surface 21 of the intermediate piece 13 according to the invention have a bevelled design with an angle of tilt 21; 22. The angle of tilt 22 for the pole surfaces 18 of the pole plates 2; 3 and for the counterpole surfaces 17 of the counterpole piece 11 in the direction of closure 23 of the door leaf 8 is an acute angle of 1 to 3 degrees, whereby the distance between the pole surfaces 18 and the counterpole surfaces 17 at a position close to the closed position of the door leaf 8 in the door frame 1 is different, i.e., the distance between the pole Add surface 18 of the pole plate 2 and the counterpole surface 17 of the counterpole piece 11 standing opposite to this is greater than the distance between the pole surface 18 of the pole plate 3 and the counterpole surface 17 of the counterpole piece 11 standing opposite to this. The angle of tilt 23 of the front surface 21 of the intermediate piece 13 is designed as an acute angle in the direction of the door leaf 8 and is likewise 1 to 3 degrees.

This advantageous design of the pole surfaces 18, the counterpole surfaces 17 and the front surface 21 of the intermediate piece 13 has the result that when the magnetic field becomes effective, the hinged door leaf 8 comes into the closed position against the sealing force of the door seal 19 by overcoming the sealing force originating from the elasticity of the door seal 19 and the door leaf can be securely closed. By means of this design of the pole surfaces 18, the counterpole surfaces 17 and the front surface 21 the door leaf is slightly proud, i.e., door frame 1 and door leaf 8 are no longer in a straight line.

The action described is further strengthened by the fact that according to another refinement of the invention. the electrically active part consisting of winding 7, yoke 6 and pole plates 1; 2 is elastically supported in the frame structure 4 serving as the holder in the door frame 1 and a thrust bearing 25 is provided for this purpose. Likewise the counterpole piece 11 is elastically mounted in the framework 10 provided for this purpose. This elastic supporting or mounting has the result that the pole surfaces 18 and the counterpole surfaces 17 are completely supported after being acted upon by a magnetic field.

Another technical measure to ensure reliable positioning of the counterpole piece 11 in the closing phase in the closed position is provided according to the invention at the counterpole piece 11. Said counterpole piece has a nose-shaped projection at the side of the counterpole piece 11 which is in the opposite direction to the direction of closure. This has the effect that the pole surfaces 18 and the counterpole surfaces 17 can only move onto each other as soon as the closing position is reached.

As soon as in the closing variant no more voltage is applied to the electromagnetic winding 7 or in the opening variant by application of a voltage to the electromagnetic winding 7 to produce a homopolar field, the magnetic field is no longer present as a restraining force and merely a remanent magnetism is active, holding the movable door leaf 8 in the closed position. By means of the released sealing force of the door seal 19 or by means of a slight pushing of the hinged door leaf 8 said door leaf can then be opened since the return spring 12 provided at the rear end of the framework 10 becomes effective and the intermediate piece 13 with the counterpole piece 11 is brought into an initial position by the return spring 12 whereby the intermediate piece 13 no longer engages in the free space 14 between the pole plates 2; 3.

The advantage of the solution according to the invention is that the closing and opening device has no movable parts which are subject to wear or can be impaired by the action of external forces.

The device according to the invention is either actuated by applying a voltage to the electromagnetic winding 7 via remote control provided that the person operating the actuation of the door is inside the building where the electrical switch for the actuation is provided.

Another possibility for actuation of the closing and opening device according to the invention by authorised persons who wish to actuate the hinged door leaf 8 from outside is that the deactivation of the electromagnetic field can either be actuated mechanically via a microswitch not shown, whereby this actuation can be accomplished, for example, via a normal cylinder lock, or by means of a break relay not shown, which is controlled by means of an electronic circuit equipped with a deactivatable identification technology. Known possibilities, e.g. coded magnetic cards or transponders are available as identification technology.

The closing and opening device is activated automatically, controlled by a sensor, for example after the movable door leaf 8 has fallen back into the door stop 16 of the door frame 1.

List of reference symbols used

| | |
|---|---|
| 1 | Door frame |
| 2 | Pole plate |
| 3 | Pole plate |
| 4 | Frame structure |
| 5 | Retaining plate |
| 6 | Yoke |
| 7 | Winding |
| 8 | Door leaf |
| 9 | Retaining plate |
| 10 | Framework |
| 11 | Counterpole piece |
| 12 | Return spring |
| 13 | Intermediate piece |
| 14 | Free space |
| 15 | End |
| 16 | Adjusting screw |
| 17 | Counterpole surface |
| 18 | Pole surface |
| 19 | Door seal |
| 20 | Doorstop |
| 21 | Front surface |
| 22 | Angle of tilt |
| 23 | Angle of tilt |
| 24 | Direction of closure |
| 25 | Thrust bearing |

1. An electromagnetic closing and opening device for hinged door leaves, consisting of an electrically active part provided in a door frame with an electromagnetic winding forming an electromagnetic field and two flat pole plates connected one to the other via a yoke as well as a U-shaped and movable counterpole piece, provided in a door leaf, which closes the field lines of the generated magnetic field, which has an intermediate piece protruding slightly beyond the counterpole surfaces of said counterpole piece, characterised in that the closing counterpiece consists of a framework (10) connected to a retaining plate (9) and therein is provided a U-shaped movable counterpole piece (11) having two pole surfaces, whereby these pole surfaces are positioned opposite to the flat poles of the pole plates (2; 3) of the closing and opening device in the closed position, whereby between the poles of the counterpole piece (11) there is provided an intermediate piece (13) which extends slightly over the surfaces of this pole in the direction of the flat pole of the pole plates (2; 3) and protrudes beyond the counterpole piece (11) which is connected to a supporting return spring (12) in an end (15) of the framework (10) of the closing counterpiece.

2. The device according to claim 1, characterised in that in the door frame (1′) there is provided the closing and opening device forming the electromagnetic field and in the movable door leaf (8) there is provided the closing counterpiece.

3. The device according to claims 1 and 2, characterised in that the closing and opening device with the electromagnetic coil (7), wound around a yoke (6) in a flat design, whereby the yoke (6) is connected to two pole plates (2; 3) and the coil (7) with the yoke (6) and pole plates (2; 3) inside a frame structure (4) which is connected to a retaining plate (5), are combined to form a structural unit.

4. The device according to claims 1 to 3, characterised in that there is provided an intermediate piece (13) consisting of a non-magnetisable material, protruding slightly beyond the counterpole surfaces (17) of the counterpole piece (11) and either the two counterpole surfaces (17) of the U-shaped counterpole piece (11) in the direction of closure (24) of the movable door leaf (8) and the intermediate piece (13) protruding slightly over the counterpole surfaces (17) of the counterpole piece (11) and extending in the direction of the pole surfaces (17) of the pole plates (2; 3) with the electromagnetic winding (7) and/or the pole surfaces (18) of the pole plates (2; 3) each exhibit an angle of tilt (22; 23).

5. The device according to claims 1 to 4, characterised in that the counterpole piece (11) is designed as a permanent magnet, an intermediate piece (13) protruding slightly beyond the counterpole surfaces (17) of the counterpole piece (11) consists of a non-magnetic material and either the two counterpole surfaces (17) of the U-shaped counterpole piece (11) in the direction of closure (24) of the movable door leaf (8) and an intermediate piece (13) protruding slightly over the counterpole surfaces (17) of the counterpole piece (13) and extending in the direction of the pole surfaces (18) of the pole plates (2; 3) with the electromagnetic winding (17), and/or the pole surfaces (18) of the pole plates (2; 3) each exhibit an angle of tilt (22; 23).

6. The device according to claims 1 to 5, characterised in that the pole surfaces (18) of the pole plates (2; 3) which vertically delimit the pole plates (2; 3) towards the counterpole surfaces (17) of the counterpole piece (11) exhibit an angle of tilt (22) with respect to a normal to a perpendicular surface of the door frame (1), which is designed as an acute angle in the direction of closure (24) of the door leaf (8) and lies between 1 and 5 degrees.

7. The device according to claims 1 to 6, characterised in that the counterpole surfaces (17) of the counterpole piece (11) exhibit an angle of tilt (22) towards a normal to a perpendicular surface of the door leaf (8), which is designed as an acute angle in the direction of closure (24) of the door leaf (8) and lies between 1 and 5 degrees.

8. The device according to claims 1 to 7, characterised in that the electrically active part provided in the door frame (1), consisting of an electromagnetic winding (7) forming an electromagnetic field and two flat pole plates (2; 3) connected one to the other via a yoke (6) can be moved in the door frame (1) in the direction of closure of the movable door leaf (8), whereby an elastic thrust bearing (25) is provided at one end of the electrically active part inside the door frame (1) facing away from the door leaf (8) and the retaining plate (5) has for this purpose a corresponding recess enabling the movement of the electrically active part and at the same time delimiting the recess, which is a gap width of a few millimeters greater than the width of the pole plates (1; 2) delimiting the electrically active part and connected via the yoke (6).

9. The device according to claims 1 to 8, characterised in that the electrically active part can be rotated about the elastic thrust bearing (25) and a tolerance of 0.5 to 2.0 mm is provided in the retaining plate (5).

10. The device according to claims 1 to 9, characterised in that the movable counterpole piece is supported elastically in the frame to accommodate said counterpole piece and a tolerance of 0.5 to 2.0 mm to the vertical guide of the counterpole piece is provided in the retaining plate (9) located in the hinged door leaf.

11. The device according to claims 1 to 10, characterised in that either the counterpole piece (11) of the pole surface facing away from the direction of motion of the hinged door leaf or the oppositely positioned pole plate (1) is provided with a nose-shaped projection.

12. The device according to claims 1 to 11, characterised in that the closing and opening device is provided on the door side in the door frame (1) at a predefined height for door handles inside a frame recess whereby the retaining plate (5) is let into the profile of the door frame (1).

13. The device according to claims 1 to 12, characterised in that the retaining plate (5) has a recess for the pole plates (2; 3) including the electromagnetic coil (7), whereby the pole plates (2; 3) protrude slightly beyond the retaining plate (5).

14. The device according to claims 1 to 13, characterised in that the closing counterpiece on the door side is positioned in the hinged door leaf (8) at the same height as in the closing and opening device inside a recess in the profile of the door leaf (8).

15. The device according to claims 1 to 14, characterised in that the frame (12) with the closing counterpiece is connected to the retaining plate (9) which is provided with a recess for the counterpole piece (11) and that on the frame side the retaining plate (9) has a seal with the door profile.

16. The device according to claims 1 to 15, characterised in that the closing and opening device is connected to an electronic circuit for application of voltage to the electromagnetic coil (7) of the closing and opening device.

17. The device according to claims 1 to 16, characterised in that the electronic circuit for switching the closing and opening device in the closed position of the hinged door leaf (8) is provided in the region of the door frame (1) or the door leaf (8) with sensors which automatically activate the closing and opening device.

18. The device according to claims 1 to 17, characterised in that mechanically actuatable sensors or an electronic identification technology is provided for the deactivation of the electronic circuit for actuation of the closing and opening device.

19. The device according to claims 1 to 18, characterised in that transponder technology is used as identification technology to deactivate the electronic circuit.
